(19) United States
(12) Patent Application Publication
(10) Pub. No.: US 2026/0287968 A1
(43) Pub. Date: Sep. 24, 2026

(54) Optical Detection and Optical Switch Based on Interference between Narrow Beams

(71) Applicant: Chian Chiu Li, Fremont, CA (US)

(72) Inventor: Chian Chiu Li, Fremont, CA (US)

(21) Appl. No.: 19/686,803

(22) Filed: May 25, 2026

Related U.S. Application Data
(63) Continuation-in-part of application No. 18/889,320, filed on Sep. 18, 2024, now Pat. No. 12,674,703.

(51) Int. Cl. G02F 1/313; G01J 1/44

(52) U.S. Cl. CPC G02F 1/3137; G01J 1/44; G01J 2001/442

(57) ABSTRACT

Methods and apparatus for optical detection and optical switches. In optical detection, a weak beam and a strong beam have a width smaller than the wavelength and are spaced apart by a distance smaller than the wavelength. Interference between the beams is used to detect the weak beam. In optical switching, two beams have a width smaller than the wavelength and are spaced apart by a distance smaller than the wavelength. The beams interfere to generate an output beam. One of the beams is used to control the output beam to perform optical switching.

### CROSS REFERENCE TO RELATED APPLICATION

This is a continuation-in-part of U.S. application Ser. No. 18/889,320, filed Sep. 18, 2024, which is a continuation-in-part of U.S. application Ser. No. 17/902,819, filed Sep. 3, 2022, now U.S. Pat. No. 12,146,788, granted Nov. 19, 2024. This application is related to U.S. patent application Ser. No. 15/477,118, filed Apr. 3, 2017, now U.S. Pat. No. 10,601,131, granted Mar. 24, 2020, the entire content of which is incorporated herein by reference.

### FIELD OF INVENTION

This invention relates to methods and apparatus based on interference between narrow beams, and particularly to weak beam detection, optical switches, optical transistors, and optical memory.

### BACKGROUND OF THE INVENTION

In optical detection, photodiodes are often used as photodetectors. Photodiodes convert an incoming optical signal into an electrical signal. After photons impinge on a photodiode, they are absorbed in an active region of the photodiode, creating electron-hole pairs. The photo-generated charges form an electrical current in an electrical field that is subsequently measured.

When an optical signal is weak, i.e., an optical beam under test has low intensity, the generated electrical current can become too weak for a regular photodiode to detect. Examples of extreme weak signals include single photons. A weak electrical signal can be amplified by charge multiplication. Avalanche photodiodes (APDs) and single-photon avalanche diodes (SPADs) use high reverse voltage to generate charge multiplication. Photomultiplier tubes (PMTs) create charge multiplication in a vacuum tube. Both SPAD and PMT can detect single photons. Besides amplification of photocurrents, superconducting-related phenomena, where cryogenic operating temperatures are likely required, have been used to detect single photons in devices such as transition-edge sensors (TESs) and superconducting nanowire single-photon detectors (SNSPDs). To sense a single photon, a TES detects the change of electrical resistance, while an SNSPD detects a voltage pulse. In general, it is desirable to improve the photon detection efficiency (PDE) in detection of weak beams. Especially for APDs and SPADs, the PDE at wavelengths larger than 1000 nm remains a challenge.

Therefore, there exists a need to improve the PDE in weak beam detections, which may enhance the detection of weak optical signals, in particular the detection of single photons.

The term “beam” as used herein indicates any electromagnetic beam or electromagnetic wave which follows the Maxwell equations and travels in the free space (e.g., in the air or vacuum) or a waveguide. A beam may be of radiation in the optical frequency range or radio frequency range, or in between, or beyond the two ranges. The term “weak beam” as used herein indicates a beam with relatively low power or low intensity. A weak beam includes a single photon. The term “strong beam” as used herein indicates a beam with relatively higher power or higher intensity compared to a weak beam.

As used herein, the terms “optical switch” and “optical switching” indicate all-optical switch and all-optical switching, respectively. Optical switches use one optical signal to control another optical signal and have advantages such as high speed, low power consumption, and near-zero latency. There exists a need for improved optical switches, especially in optical computing and high-speed data networks.

The terms “high power” and “low power”, as used herein, indicate relative power levels. In some cases, high power indicates a power level beyond a first value, while low power indicates a power level below a second value smaller than the first value. In some other cases, if a beam's power is distinguishably higher than another beam, the beam and the other beam may be referred to as a high power beam and a low power beam, respectively.

### OBJECTS AND ADVANTAGES

Accordingly, several main objects and advantages of the present invention are:
a). to provide an improved device and method to detect weak beams;
b). to provide such a device and method that detect a weak beam by sensing the interference between the weak beam and a reference beam;
c). to provide such a device and method that detect a weak beam by sensing an output beam that is generated by the interference between the weak beam and a reference beam;
d). to provide such a device and method that detect a weak beam by sensing characteristics of an output beam that is generated by the interference between the weak beam and a reference beam;
e). to provide such a device and method that improve the PDE in optical detections when a photodiode, APD, SPAD, PMT, TES, or SNSPD is used;
f). to provide such a method and system which detect an image formed by weak beams; and
g). to provide such a method and system which use an array of reference beams to detect an image formed by weak beams; and
h). to provide an improved device and method for optical switching;
i). to provide such a device and method that use interference between narrow beams to perform optical switching; and
j). to provide devices and methods that use interference between narrow beams to make optical transistors and optical memory devices.

Further objects and advantages will become apparent from a consideration of the drawings and ensuing description.

### SUMMARY OF THE INVENTION

In accordance with the present invention, a weak bean is detected by sensing an output beam generated by the interference between the weak beam and a reference beam. The reference beam may be much stronger than the weak beam. The width of and spacing between the weak beam and reference beam are around or smaller than the wavelength, respectively. The propagation direction of the output beam is steered by the phase difference between the weak and reference beams and used to detect the weak beam. The PDE may be improved in optical detections based on photodiodes, APD, SPAD, PMT, TES, or SNSPD. Further, an image formed by weak beams may be detected by interference between the weak beams and an array of reference beams. The reference beams may be generated through an array of holes etched on waveguides.

Further, interference between narrow beams is utilized to make optical switches, optical transistors, and optical memory devices. A beam may be used to control an optical switch, an optical transistor, or an optical memory device.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings.

FIG. 1 shows a prior-art method to detect a beam.

FIGS. 2A to 2F illustrate methods to detect a weak beam using a strong beam schematically.

FIGS. 3 and 4 show embodiments to detect a target schematically.

FIGS. 5 and 6 illustrate embodiments to detect a single photon schematically.

FIGS. 7A to 7D illustrate embodiments to detect an image schematically.

FIG. 7E illustrates schematically an arrangement of image detection using the embodiments shown in FIGS. 7A-7D.

FIGS. 8A to 8B illustrate another embodiment to detect an image schematically.

FIGS. 9A to 9D illustrate another embodiment to detect an image schematically.

FIG. 10 illustrates a configuration to detect an image schematically.

FIGS. 11A to 11C illustrate a configuration of an optical switch schematically.

FIGS. 12A and 12B illustrate configurations of optical switches schematically.

FIG. 13 illustrates a configuration of another optical switch schematically.

FIGS. 14A to 14C illustrate configurations of optical transistors schematically.

FIGS. 15A to 15H illustrate a configuration for multiple optical transistors schematically.

FIGS. 16A to 16D illustrate a configuration of an optical memory unit schematically.

### DETAILED DESCRIPTION

The following exemplary embodiments are provided for complete disclosure of the present invention and to fully inform the scope of the present invention to those skilled in the art, and the present invention is not limited to the schematic embodiments disclosed, but can be implemented in various types. Wherever possible, the same reference numbers are used throughout the drawings to refer to the same or like parts.

FIG. 1 is a prior-art setup for detecting a beam 10. A detector 12 can be a photodetector that detects the intensity of beam 10 by converting optical signals into electrical signals. The electrical signals are measured by a sensing circuit 14 and then recorded. When the intensity of beam 10 is below a certain level, the electrical signals become too weak for sensing circuit 14 to ascertain. The conventional method as shown in FIG. 1 detects a beam by directly sensing the intensity of the beam. The method is limited by the intensity level.

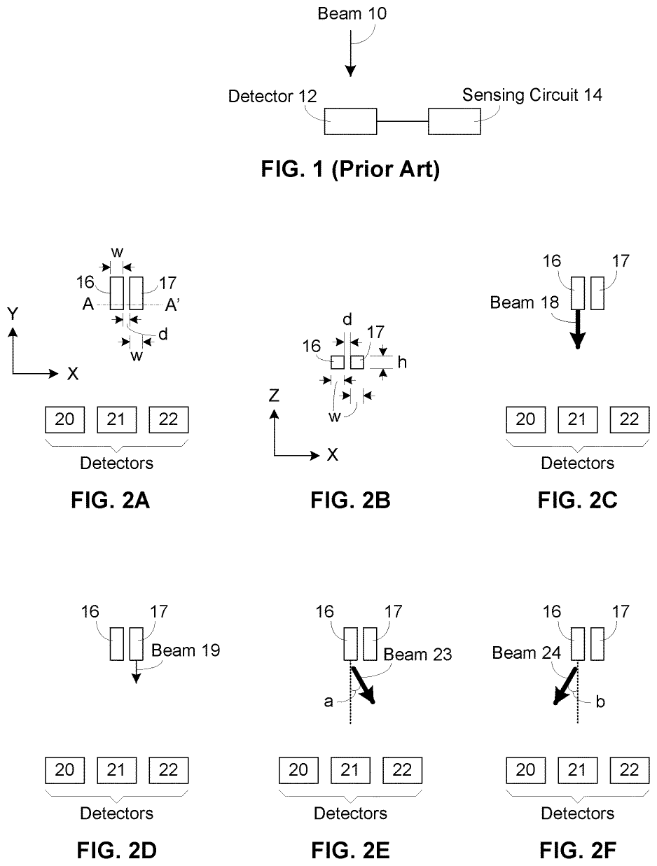

FIGS. 2A-2F schematically show top and cross-sectional views of a configuration for detecting a weak beam, according to embodiments of the present disclosure. The top views shown in FIGS. 2A and 2C-2F are in an X-Y plane, while the cross-sectional view shown in FIG. 2B is in an X-Z plane and taken along a line AA depicted in FIG. 2A. As in FIGS. 2A and 2B, waveguides 16 and 17 may be formed on a substrate (not shown) and have a width w in the X direction and height h in the Z direction. Waveguides 16 and 17 and detectors 20, 21, and 22 are disposed in the air or vacuum. The ends of waveguides 16 and 17 are aligned to a position at the Y axis. The spacing between waveguides 16 and 17 is d in the X direction. The width w, height h, and spacing d are around or smaller than the wavelength of beams 18 and 19, respectively. Optionally, the term “around or smaller than the wavelength” as used herein indicates smaller than one and a half times of the wavelength.

Waveguides 16 and 17 emit coherent beams 18 and 19, respectively, as shown in FIGS. 2C and 2D. When the spacing, width, and height of waveguides 16 and 17 are around or smaller than the wavelength, after beams 18 and 19 are emitted, the spacing between the beams in the X direction and the widths of beams 18 and 19 in the X and Z directions are around or smaller than the wavelength. Beams 18 and 19 spread in the X and Z directions while propagating in the Y direction in the free space (i.e., in vacuum or the air). The beams mix and interfere with each other to form an output beam. Further, when beams 18 and 19 are entirely transmitted into a subwavelength space or a tiny space with dimensions around or smaller than the wavelength in the X and Z directions, i.e., when beams 18 and 19 are injected only into the tiny space, they may not coexist as two separate beams in the tiny space. Instead, the output beam is formed as a single beam in the tiny space at the time when beams 18 and 19 are emitted, which may be referred to as a phenomenon of beam singularity or a beam singularity effect. The beam singularity effect also occurs when more than two beams are transmitted into the tiny space.

Detectors 20, 21, and 22 may be a photodiode, APD, SPAD, PMT, TES, SNSPD, or other types of detecting devices. Detectors 20-22 are used to show the detection configuration exemplarily. Three or more than three detectors may be used in some embodiments. Optionally, the detectors may form a one-dimensional (1D) array along the X direction, as depicted in the figures. In some cases, the detectors may form a two-dimensional (2D) array in an X-Z plane. Provided detectors 20-22 can detect beam 18, but cannot detect beam 19 because beam 19 is weak with an intensity level that is too low for the detectors to detect. In such cases, more sophisticated devices are required to detect beam 19 when conventional methods are used.

It is known that when a weak beam interferes with a strong beam, the weak beam can steer an output beam generated by the interference of the weak beam and strong beam, such as the methods and systems disclosed in U.S. Pat. No. 10,601,131. The power of the strong beam may be 10 times or even 100 times that of the weak beam. When beams 18 and 19 are emitted in separate time periods, the output beam is either beam 18 or beam 19 that propagates along the Y direction, as shown in FIGS. 2C and 2D. But when beams 18 and 19 are emitted at the same time, the beams interfere with each other, generating an output beam that propagates along a direction determined by the phase difference between beams 18 and 19. For example, an output beam 23 may be steered anticlockwise by an angle a in the X-Y plane as shown in FIG. 2E, or an output beam 24 may be steered clockwise by an angle b in the X-Y plane as shown in FIG. 2F. Hence, if beam 19 is too weak to be detected by the detectors, beam 19 may still be sensed by detecting the output beam. That is, beam 19 may be sensed without direct detection of the intensity of beam 19. In some cases, when the intensity of beam 18 is 5 times, 10 times, or even 100 times of that of beam 19, the intensity of the output beam may be around 5-100 times of that of beam 19. Thus, when detectors 20-23 cannot detect beam 19 directly by measuring its intensity, the detectors may still detect beam 19 by sensing the output beam.

The output beam may have a power level much higher than that of beam 19 and detectors 20-23 are arranged to measure the output beam. As such, the photon detection efficiency (PDE) of the detection system may be increased compared to detecting the intensity of beam 19 directly. Further, when beam 19 contains a single photon, i.e., beam 19 contains a single photon during a time period, beam 18 may contain, e.g., 10-100 photons. In such cases, detection of a single photon may be replaced by detection of multiple photons or tens of photons. Then, the requirements and cost of single photon detection may be reduced in some cases.

In some aspects, before detecting a weak beam, a relatively strong reference beam is provided. Detection of the weak beam is performed by ascertaining the change of an output beam that is generated by the interference between the weak and strong beams. The propagation direction of the output beam is determined by the phase difference between the two beams. When the weak beam is not present, the output beam is the strong beam and has an initial propagation direction. Once the weak beam is present, the interference occurs. The propagation direction of the output beam changes, so does the optical path of the output beam. Any of these changes indicates detection of the weak beam. Further, the change of other characteristics may also be used, such as the position, size, shape, and intensity distribution of the light spot of the output beam. The output beam may be detected by multiple detectors or a detector array (e.g., a 1D or 2D array) disposed in a plane. The position, size, shape, and intensity distribution of the light spot may be detected in the plane. The spot position, spot size, spot shape, and spot intensity distribution are determined by the power level difference and phase difference of the two beams, and utilized to ascertain the weak beam.

As used herein, the term “spot position” of a beam indicates a position where the intensity of the beam is maximal; the term “spot size” of a beam indicates a dimension of an area where the intensity of the beam is above a given value; the term “spot shape” of a beam indicates a shape of an area where the intensity of the beam is above a given value; and the term “spot intensity distribution” of a beam indicates the intensity distribution in the spot of the beam. These characteristics are measured in a plane where detectors are arranged.

In some embodiments, a lens system (not shown) may be disposed between waveguides 16 and 17 and detectors 20-22. The lens system may generate a focused beam that impinges on detectors 20-22. In these cases, detectors 20-22 may be placed at a certain distance from the waveguides, and do not need to be very close to the waveguides.

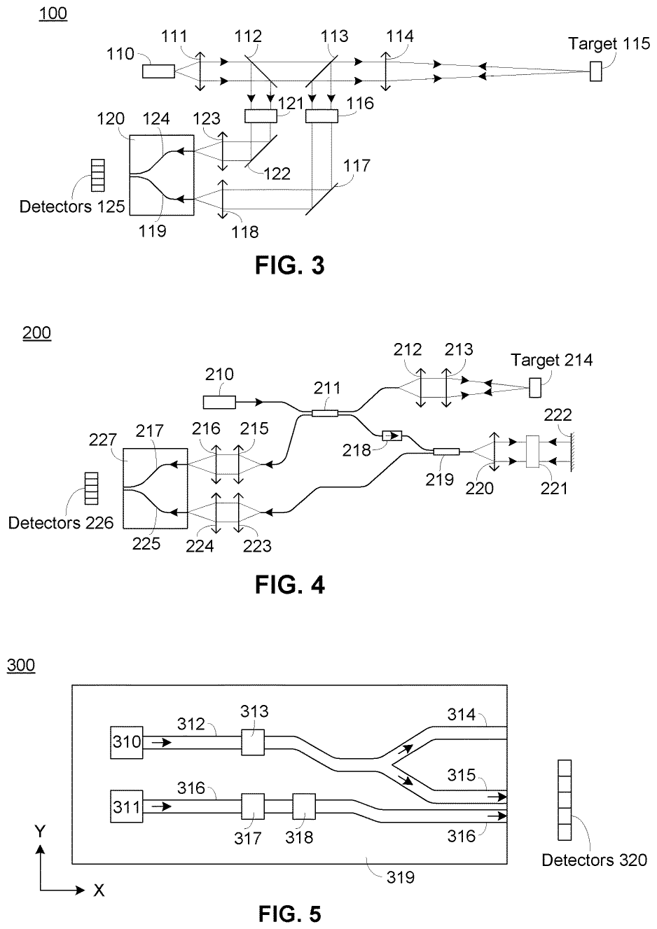

FIG. 3 is schematic diagram that illustrates a top view of a configuration 100, according to embodiments of the present disclosure. Configuration 100 may be used to detect a target and the range of the target. For example, a light detection and ranging (LiDAR) system may be built based on the configuration.

As shown in FIG. 3, a beam is generated by a light source 110. Optionally, light source 110 is a laser system and the beam is a coherent beam. The beam becomes a collimated beam after passing through a lens system 111, and then is split into two beams by a partial reflector 112. One of the beams propagates forward, passes through another partial reflector 113, and is focused by a lens system 114. In some cases, the reflectivity of reflector 113 is around 50%. The focused beam impinges onto a target 115. Thereafter, a reflected beam, as a signal beam, returns from the target 115 and is collimated by lens system 114. The signal beam is reflected by reflector 113, reflected by a mirror 117 after passing through a modulator 116, and coupled into a waveguide 119 by a lens system 118. Waveguides 119 and 124 are formed on a substrate 120. Provided that the reflectivity of reflector 112 is low, e.g., lower than 1%. A small portion of the beam from light source 110, as a reference beam, is reflected by reflector 112, reflected by a mirror 122 after passing through a modulator 121, and coupled into waveguide 124 by a lens system 123. Modulator 116 is arranged to adjust the phase of the signal beam. Modulator 121 is arranged to adjust the phase and attenuate the power of the reference beam.

The signal and reference beams travel in waveguides 119 and 124, respectively. Similar to waveguides 16 and 17 shown in FIGS. 2A-2F, the width and height of waveguides 119 and 124 are around or smaller than the wavelength of the signal and reference beams. The spacing between waveguides 119 and 124 is around or smaller than the wavelength at the edge of the substrate that faces detectors 125. After the signal and reference beams are emitted from the waveguides, the spacing between the beams and the widths of the beams in a plane perpendicular to the substrate are around or smaller than the wavelength. Provided the signal and reference beams are coherent. The signal and reference beams interfere to form an output beam.

When there is no signal beam, the output beam is the reference beam. When the signal beam comes, the propagation direction of the output beam is changed by the interference, which may be detected by detectors 125. For optimized detection result, the phase of the signal beam may be adjusted by modulator 116, while the phase and power level of the reference beam may be adjusted by modulator 121. The phase difference between the signal beam and reference beam may be tuned to change the propagation direction of the output beam to make it more detectable. Optionally, the power of the reference beam is attenuated more when the signal beam is weaker. In some cases, detectors 125 may be a 1D or 2D detector array. Optionally, a lens system (not shown) may be placed between substrate 120 and detectors 125 that focuses the output beam and projects a spot or spots of the output beam on detectors 125. Detectors 125 may include a photodiode, APD, SPAD, PMT, TES, SNSPD, or other types of optical detecting devices.

Based on configuration 100, a weak signal beam from target 115 may be detected by ascertaining one or more characteristics of the output beam. The characteristics include the propagation direction of the output beam, and the position, size, shape, and intensity distribution of the light spot of the output beam. Compared to systems based on direct intensity measurement of a weak signal beam, the detection range of configuration 100 may be larger.

FIG. 4 is schematic diagram that illustrates a top view of a configuration 200, according to aspects of the present disclosure. Configuration 200 may be used to detect a target or sample. For example, a system of low-coherence interferometry (LCI) such as optical coherence tomography (OCT) may be built based on the configuration.

As shown in FIG. 4, a beam is generated by a light source 210 and fed into an optical fiber. In some cases, light source 210 may be a laser system. Optionally, light source 210 may be a low-coherence source, such as a light emitting diode (LED), a super luminescent diode (SLD), or an amplified spontaneous emission (ASE) light source. The beam is split into a first part and a second part by a fiberoptic coupler 211. The ratio of power between the first and second part may be around 50:50 in certain cases. The first part travels along a fiber and becomes a collimated beam after passing through a lens system 212. The collimated beam is focused by a lens system 213. The focused beam impinges onto a target or sample 214. Thereafter, a reflected beam, as sample signals, returns from the target 214 and is collimated by lens system 213. The sample signals are then fed into the fiber by lens system 212, split by coupler 211, and coupled into a waveguide 217 at the front edge of a substrate 227 by lens systems 215 and 216.

The second part, as reference signals, passes through a fiberoptic isolator 218, before entering another coupler 219. Fiberoptic isolator 218 is a device that allows signals to pass along one direction with low loss, while causes high loss of optical power along the opposite direction. It may be used to limit light reflected back to the light source to reduce interference with the light source. Optionally, another fiberoptic isolator (not shown) may be placed between light source 210 and coupler 211. Coupler 219 may divide the reference signals with a 50:50 split ratio. The reference signals are split by coupler 219, collimated by a lens system 220, and then reflected by a mirror 222. A modulator 221, disposed between coupler 220 and mirror 222, is arranged to adjust the phase and attenuate the power of the reference signals. Optionally, modulator 221 may also be used to adjust the optical path length of the reference signals. In some embodiments, mirror 222 is movable and used for changing the optical path length. The reference signals reflected from mirror 222 are fed into the fiber, split by coupler 219, and launched into a waveguide 225 at the front edge of substrate 227 by lens systems 223 and 224.

Waveguides 217 and 225 are formed on substrate 227. The sample and reference signals propagate along waveguides 217 and 225, respectively. Similar to waveguides 16 and 17, the width and height of waveguides 217 and 225 are around or smaller than the wavelength of the sample and reference signals. The spacing between waveguides 217 and 225 is around or smaller than the wavelength at the rear edge of the substrate that faces detectors 226. After the sample and reference signals are emitted from the waveguides at the rear edge of the substrate, they become a sample beam and reference beam, arranged side by side. The spacing between the sample and reference beams and the widths of the beams in a plane parallel to the rear edge of and perpendicular to the substrate are around or smaller than the wavelength. The signal and reference beams interfere to form an output beam.

When there is no signal beam, the output beam is the reference beam. When the signal beam is present, the propagation direction of the output beam may be changed by the interference between the two beams. The output beam is detected by detectors 226. In some embodiments, the phase difference between the sample beam and reference beam is adjusted by modulator 221, and is used to change the propagation direction of the output beam. The propagation direction of the output beam may be tuned to facilitate the detection. For applications of LCI or OCT, modulator 221 and/or movable mirror 222 may be adjusted such that the optical path length of the reference beam matches that of the sample beam. The optical path length corresponds to an optical path from light source 210 to one of detectors 226. As such, the phase difference between the sample and reference beams is close to zero. Thus, the sample beam will not be detected by sensing the propagation direction of the output beam. In such cases, the sample beam may be detected by ascertaining the spot size, spot shape, and/or spot intensity distribution of the output beam. The power of the reference beam is adjusted by modulator 221 so that the ratio of power between the reference beam and sample beam may be a value in a range of, for example, from 5 to 100. The reference beam is attenuated more when the signal beam is weaker.

In some cases, detectors 226 may be a 1D or 2D detector array extending in a plane perpendicular to substrate 227 and parallel to the rear edge of the substrate. Optionally, a lens system may be placed between substrate 227 and detectors 226 that focuses the output beam and projects a spot or spots of the output beam on detectors 226. Detectors 226 may include a photodiode, APD, SPAD, PMT, TES, SNSPD, or other types of optical detecting devices.

Based on configuration 200, a weak sample beam from a target or sample may be detected by ascertaining characteristics of an output beam. Compared to conventional systems, a deeper probing depth at a sample may be achieved in LCI and OCT applications.

FIG. 5 is schematic diagram that illustrates a top view of a configuration 300 in an X-Y plane, according to embodiments of the present disclosure. Configuration 300 may be used to detect a weak beam, especially a single photon. Some systems that detect single photons may be made based on the configuration. For example, a quantum random number generator (QRNG) may be constructed using methods of configuration 300.

Configuration 300 includes light sources 310 and 311, waveguides 312 and 316 built on a substrate 319, and detectors 320. Provided light source 310 is a single-photon source that emits a single photon at a time or at a desired time. The beam from light source 310 may be referred to as an initial beam. Light source 311 generates a reference beam that contains multiple photons. Provided the initial and reference beams are coherent. The initial beam travels along waveguide 312. A modulator 313 is arranged to adjust the phase of the initial beam. Waveguide 312 is split into waveguides 314 and 315 by a Y structure (i.e., a Y-shaped waveguide structure) after the initial beam passes through modulator 313. The Y structure is used as a splitter to divide the initial beam into two parts with a 50:50 split ratio in terms of power level. In some other cases, the Y structure may also be used as a combiner to combine two beams, when the beams travel in the reverse direction.

Light source 311 launches the reference beam in waveguide 316. The reference beam passes through modulator 317 and attenuator 318 that adjust the phase and reduce the power of the reference beam, respectively. Waveguides 315 and 316 are brought together at the edge of substrate 319. Similar to waveguides 217 and 225 of FIG. 4, the width and height of waveguides 312 and 314-316 are around or smaller than the wavelength of the initial and reference beams. The spacing between waveguides 315 and 316 is around or smaller than the wavelength at the edge of the substrate that faces detectors 320.

Since the Y structure splits the initial beam by a ratio of 50:50, a single photon has 50% chance to enter waveguide 315. Whether the single photon is fed into waveguide 315 is a random phenomenon in a quantum process. The beam propagating in waveguide 315 is referred to as a signal beam, which contains either a single photon or zero photon. Initially, light source 310 is off. The reference beam is the output beam. After light source 310 is turned on, the signal beam is sensed by detecting the change of the output beam. When the signal beam contains a single photon, the interference between the signal and reference beams happens, and the propagation direction of the output beam may be steered based on the phase difference. When waveguide 315 is empty, no interference occurs, the reference beam becomes the output beam, and the direction of the output beam remains unchanged. Hence, the signal beam may be detected by sensing the propagation direction of the output beam. As the signal beam is a single photon, the reference beam may have 50-100 photons. The power of the reference beam may be controlled by light source 311 and attenuator 318. Thus, detecting a single photon is changed into detecting multiple photons.

The output beam is detected by detectors 320. Similar to detectors 125 and 226, detectors 320 may be a 1D or 2D detector array. Optionally, a lens system (not shown) may be placed between substrate 319 and detectors 320 to focus the output beam on detectors 320. Detectors 320 may include a photodiode, APD, SPAD, PMT, TES, SNSPD, or other types of optical detecting devices.

As illustrated above, waveguide 315 has no photon and the output beam is the reference beam at the beginning. The output beam is monitored by detectors 320 continuously. After light source 310 is turned on, waveguide 315 may carry a single photon on the random basis. When waveguide 315 emits a signal beam, i.e., a single photon, the interference of the single photon and the reference beam changes the propagation direction of the output beam. The phase difference between the signal and reference beams may be tuned by adjusting modulator 313 and/or 317, which changes the propagation direction of the output beam. The power ratio between the two beams may be adjusted via attenuator 318. Optimized phase difference and power ratio may be obtained to enhance the sensitivity and accuracy of single-photon detection.

The propagation direction of the output beam may be measured using the spot position. In addition, other characteristics of the output beam, such as spot shape, spot size, and/or spot intensity distribution, may be detected by detectors 320 and used to sense a single photon.

Compared to systems based on direct measurement of a single photon by certain detectors, the methods illustrated above may detect a single photon by sensing multiple photons, such as 50-100 photons, by the same detectors. As such, the PDE may be improved. Further, less sophisticated detectors may be used to lower the detection cost in some cases.

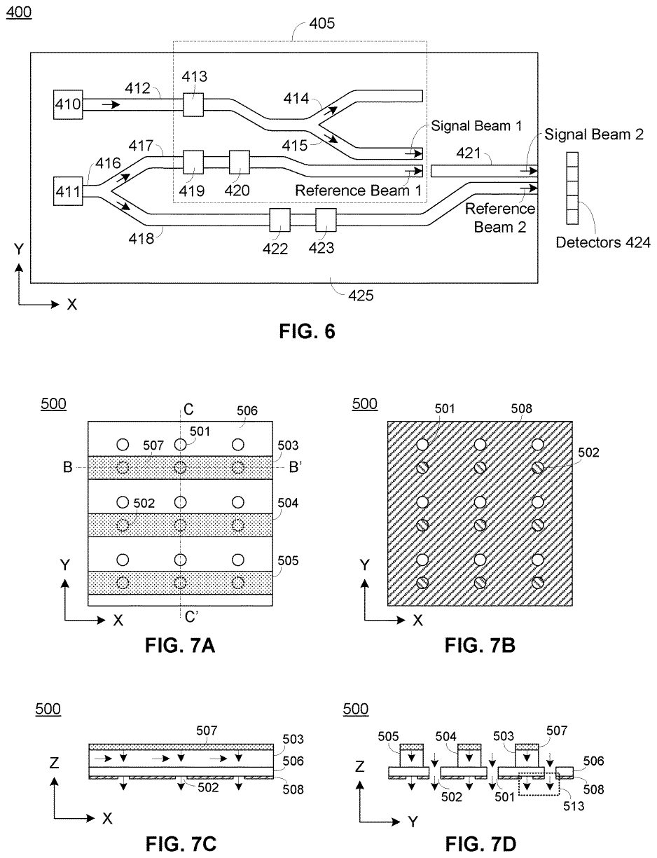

FIG. 6 is schematic diagram that illustrates a top view of a configuration 400 in an X-Y plane, according to embodiments of the present disclosure. Similar to configuration 300, configuration 400 may be used to detect a weak beam, especially single photons in systems like the QRNG. Configuration 400 includes two signal beams (e.g., signal beam 1 and signal beam 2), and two reference beams (e.g., reference beam 1 and reference beam 2). Provided signal beam 1 and reference beam 1 are coherent, and signal beam 2 and reference beam 2 are coherent. Configuration 400 also includes a section 405 that has similar structures to those of configuration 300. Section 405, as illustrated by dashed lines in FIG. 6, may be considered as the first detection stage. Signal beam 1 interferes with reference beam 1 to produce an output beam 1 at the first detection stage. Output beam 1 is converted into signal beam 2 that interferes with reference beam 2 to produce an output beam 2 at the second detection stage. Output beam 2 is used to detect whether signal beam 1 contains a single photon.

Configuration 400 further includes light sources 410 and 411, waveguides 412 and 416-418 on a substrate 425, and detectors 424. Provided light source 410 is a single-photon source, and light source 411 generates a beam with multiple photons. Light source 410 launches an initial beam in waveguide 412 that is split into waveguides 414 and 415 by a Y structure (e.g., a Y-shaped waveguide structure). The Y structure is made to split a beam into two parts with a split ratio of 50:50. The initial beam passes through a modulator 413 that modulates the phase of the initial beam.

Light source 411 launches a reference beam in waveguide 416 that is connected to waveguides 417 and 418 via a splitting structure. The splitting structure divides the reference beam into a reference beam 1 and a reference beam 2. Reference beams 1 and 2 travel along waveguides 417 and 418, respectively. Reference beam 1 passes through modulator 419 and attenuator 420 that adjust the phase and attenuate the power of reference beam 1, respectively. Reference beam 2 passes through modulator 422 and attenuator 423 that adjust the phase and attenuate the power of reference beam 2, respectively. Waveguides 415 and 417 are brought together at the ends of the waveguides. Waveguide 418 and another waveguide 421 are brought together at the edge of the substrate 425.

Similar to waveguides 16 and 17 of FIG. 2B, the width and height of the waveguides shown in FIG. 6 are around or smaller than the wavelength of the initial and reference beams. The spacing between waveguides 415 and 147 is around or smaller than the wavelength at the ends of the waveguides. The spacing between waveguides 418 and 421 is around or smaller than the wavelength at the edge of the substrate that faces detectors 424.

Since the Y structure splits the initial beam by a ratio of 50:50, a single photon has 50% chance to enter waveguide 415. Whether the single photon is fed into waveguide 415 to become signal beam 1 is a random phenomenon in a quantum process. Provided reference beam 1 has 100 photons after passing through attenuator 420. The power of reference beam 1 is controlled by light source 411, the splitting structure, and attenuator 420.

At the beginning, light source 410 is off and light source 411 is turned on. Thus, signal beam 1 has zero power. Reference beam 1 is emitted from waveguide 417 to become output beam 1. As waveguide 417 is aligned with waveguide 421 and separated from it by a certain short distance, output beam 1 is aligned with waveguide 421, and a large portion (e.g., 80%) of output beam 1 may be coupled into waveguide 421. Optionally, a lens may be inserted between waveguides 417 and 421 to improve the coupling efficiency. The part of output beam 1 that propagates in waveguide 421 becomes signal beam 2 and is emitted from waveguide 421. On the other hand, after passing through modulator 422 and attenuator 423, reference beam 2 is emitted from waveguide 418. The phase difference between signal beam 2 and reference beam 2 may be tuned by modulator 422. Signal beam 2 and reference beam 2 interfere with each other to produce output beam 2, which is detected by detectors 424. Detectors 424 may monitor output beam 2 continuously.

After light source 410 is switched on, waveguide 415 may carry a single photon on the random basis. When no photon enters waveguide 415, output beam 1 and output beam 2 remain the same as if light source 410 is still off. When a single photon enters waveguide 415 to become signal beam 1, the interference of signal beam 1 and reference beam 1 creates output beam 1. The phase difference between signal beam 1 and reference beam 1 may be tuned by adjusting modulator 413 and/or 419, which changes the propagation direction of output beam 1 such that output beam 1 becomes misaligned with waveguide 421. Provided a small portion (e.g., less than 10%) of output beam 1 is coupled into waveguide 421. The part of output beam 1 that propagates in waveguide 421 becomes signal beam 2 and is emitted from waveguide 421.

As aforementioned, assuming reference beam 1 has 100 photons. When no photon enters waveguide 415, signal beam 1 has no power, and signal beam 2 may have 80 photons. When a single photon enters waveguide 415, signal beam 1 has the single photon, and signal beam 2 may have 8 photons. As such, a single photon may be detected by sensing the change of signal beam 2 between 8 photons and 80 photons. Further, in some aspects, reference beam 2 may have 8000 photons. Detecting a single photon becomes detecting the change of output beam 2 that contains 8000 photons. The change of output beam 2 may be sensed by detecting one or more characteristics of output beam 2, e.g., the position, size, shape, and/or intensity distribution of the spot of output beam 2.

Optionally, a lens system may be placed between substrate 425 and detectors 424 to focus output beam 2 on detectors 424. Detectors 424 may include a photodiode, APD, SPAD, PMT, TES, SNSPD, or other types of optical detecting devices. Compared to systems based on direct measurement of a single photon by certain detectors, the methods illustrated above and shown in FIG. 6 detect a single photon by ascertaining, e.g., as many as 8000 photons. Hence, the PDE may be improved when the same type of detectors are used.

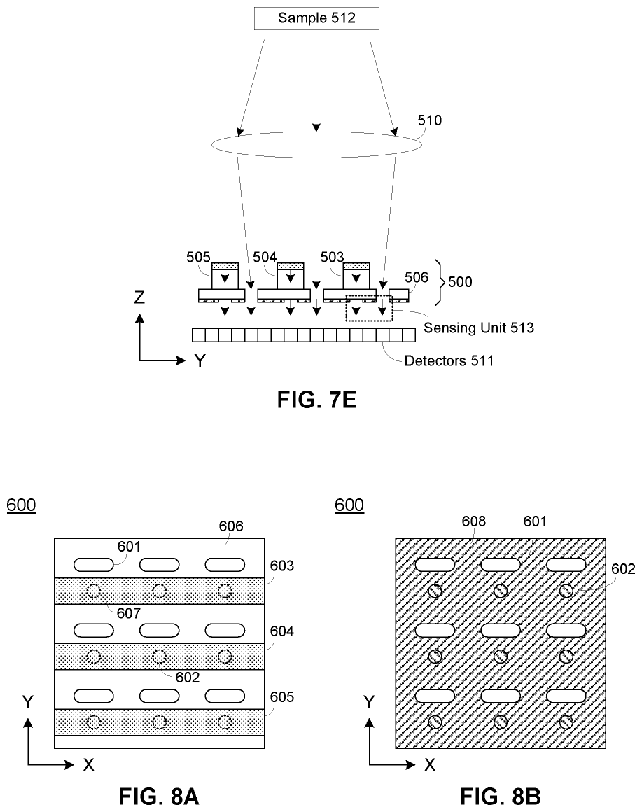

FIGS. 7A-7D show schematic views of a configuration 500 for detecting an image according to embodiments of the present disclosure. FIGS. 7A and 7B illustrate a top view and a bottom view of the configuration, respectively. FIGS. 7C and 7D illustrate cross-sectional views taken along a line BB′ and a line CC′ depicted in FIG. 7A, respectively. Arrows in the figures indicate directions of light waves in waveguides and free space. Assuming light waves and beams used herein have a preset wavelength. Configuration 500 exemplarily includes holes 501 and 502 of two different types, waveguides 503, 504, and 505 that extend in the X direction, and a substrate 506. Holes 501 are beside the waveguides. Holes 502 are under the waveguide, invisible in FIG. 7A, and depicted in dotted lines.

Holes 501 form an array, while holes 502 form another array. The two arrays have the same size, the same pattern, and are disposed in positions with a small offset. Waveguides 503-505 are made on substrate 506 and form a 1D array. Substrate 506 may also function as a cladding layer of the waveguides. Optionally, a buffer layer (not shown) may be formed between the waveguide (i.e., a core layer) and substrate 506. Optionally, a grating layer 507 is formed at the top of the waveguide, and an absorption layer 508 is deposited below substrate 506. Holes 501 penetrate through substrate 506 and absorption layer 508 completely. Holes 502 penetrate through absorption layer 508 completely. Optionally, holes 502 may penetrate into substrate 506 in some cases. Grating layer 507 may be made by etching the core layer. Grating layer 507 contains a grating coupler (not shown) that may have periodically distributed shallow grooves. Substrate 506 is between absorption layer 508 and the waveguides. Absorption layer 508 is configured to receive and absorb light waves that enter the layer, reducing the detection noise and interference.

The grating coupler couples a light wave travelling in the waveguide along the X direction and a free-space wave traveling in the Z direction through refractive index modulation. Part of the light wave in the waveguide changes the prorogation direction under the influence of the grating coupler, and propagates in the vertical direction, i.e., in and against the Z direction. As such, a small part of the light wave is transmitted out of holes 502 and becomes reference beams propagating downward against the Z direction. The array of holes 502 generates an array of the reference beams. Rest of the light waves propagating in the vertical direction either goes out of the waveguide through grating layer 507 or is absorbed by absorption layer 508.

Holes 501 and 502 have a dimension (or diameter) close to or smaller than the wavelength of the light waves in the waveguides. The separation (or spacing) between a hole 501 and its adjacent hole 502 is close to or smaller than the wavelength in the Y direction. A pair of adjacent holes 501 and 502 form a sensing unit 513 of configuration 500. An imaging mechanism or device may be made based on configuration 500. When a weak beam of the wavelength from a sample (or target) is focused on an XY plane of substrate 506, part of the beam passes through holes 501 respectively, generating weak signal beams. The signal beams propagate against the Z direction and form an image of the sample. Each signal beam passes through a corresponding hole 501, or is emitted by the corresponding hole 501. A signal beam and a reference beam at a sensing unit 513 interfere to produce an output beam. Since the signal and reference beams have dimensions and separation close to or smaller than the wavelength in an XY plane, the signal beam may be detected by sensing the output beam via the above-described methods. For example, the power of the reference beam may be at least five times larger than that of the signal beam. The signal and reference beams may come from a laser source and be coherent in some cases. The signal and reference beams may also come from a low-coherent (or broadband) light source and be incoherent in some other cases.

The image formed by the weak signal beams may be detected by using the array of the reference beams. As aforementioned, the array of the reference beams is generated by the array of holes 502. Sensing units 513 form a sensing array that has the same size and same pattern as that of holes 501 and 502. The imaging quality is related to characteristics of the sensing array, such as the pitch between adjacent sensing units and the area of the sensing array. To prevent stray beams from entering holes 501 from the waveguides, sidewalls of holes 501 and the waveguides may be coated with a reflective layer (not shown).

FIG. 7E shows schematically an arrangement using configuration 500 shown in FIGS. 7A-7D. The arrangement shown in FIG. 7E may be used to make a LiDAR, LCI, or OCT system. It contains configuration 500, a lens system 510, and detectors 511. Detectors 511 form a 2D detector array. Light waves from a sample 512 are focused in a plane of substrate 506 by lens system 510. The focused light waves are transformed into signal beams after passing through holes 501. The signal beams forms an image of sample 512. As illustrated above, two adjacent signal beam and reference beam at a sensing unit 513 interfere to generate an output beam. The signal beam is detected through sensing the output beam. After the output beams are detected, the image of sample 512 may be obtained. As described above, the reference beam may be much stronger than the signal beam. Hence, an image based on weak beams may be detected via interference between each of the weak beams and a corresponding reference beam. Detectors 511 may be the same as or similar to the aforementioned detectors (e.g., detectors 226 and 320 as shown in FIGS. 4 and 5). Optionally, another lens system (not shown) may be placed between configuration 500 and detectors 511. The other lens system focuses the output beams and projects an image formed by the output beams on detectors 511.

FIGS. 8A and 8B show schematically a top view and a bottom view of a configuration 600 for detecting an image according to embodiments of the present disclosure. The structure of configuration 600 is similar to that of configuration 500, except the shape and size difference between holes 501 and holes 601. Configuration 600 contains holes 601 and 602, waveguides 603, 604, and 605, a substrate 606, a grating layer 607 at the top of the waveguide, and an absorption layer 608 on the bottom of substrate 606. Holes 602 are invisible in FIG. 8A and depicted in dotted lines. Like holes 501, holes 601 penetrate through substrate 606 and absorption layer 608 completely. Like holes 502, holes 602 may be round and formed by etching absorption layer 608. Holes 602 only pass through absorption layer 608 in some cases. While holes 501 have a circular shape, holes 601 may have a rectangular shape with round corners and elongate in the X direction. The dimension of holes 601 in the X direction may be larger than that in the Y direction, e.g., two times larger. As the area of hole 601 is larger than that of hole 501, holes 601 may generate a stronger signal beam than holes 501. Stronger signal beams are easier to be detected, thereby facilitating image detection.

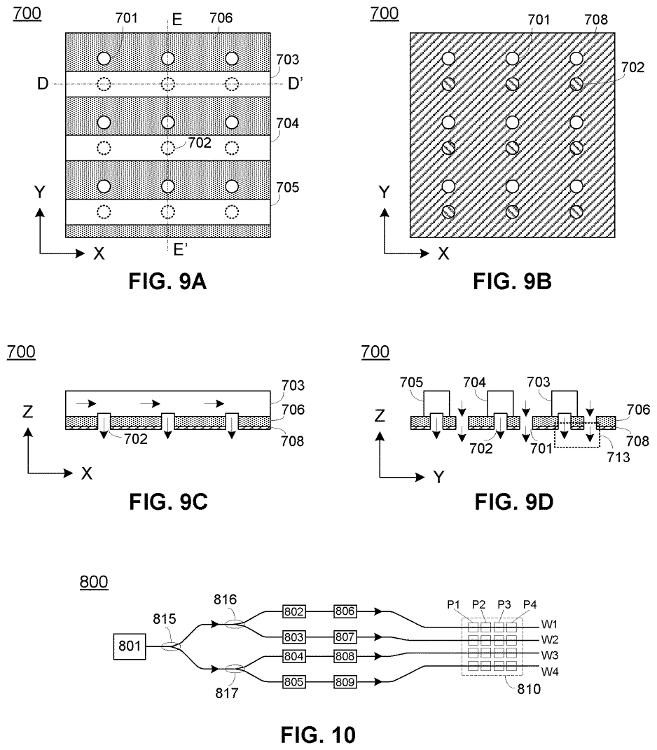

FIGS. 9A-9D show schematic views of a configuration 700 for detecting an image according to embodiments of the present disclosure. FIGS. 9A and 9B illustrate a top view and a bottom view of the configuration, respectively. FIGS. 9C and 9D illustrate cross-sectional views taken along a line DD′ and a line EE′ depicted in FIG. 9A, respectively. Arrows in the figures indicate directions of light waves in waveguides and free space. Configuration 700 exemplarily includes holes 701 and 702 of two different types, waveguides 703, 704, and 705, a substrate 706, and an absorption layer 708. As holes 702 are under the waveguides, they are invisible in FIG. 9A and depicted in dotted lines. Holes 701 form an array, while holes 702 form another array. The two arrays have the same size, the same pattern, and a position offset. Waveguides 703-705 are formed on substrate 706 and extend in the X direction. Substrate 706 may also be a cladding layer of the waveguides. Optionally, a buffer layer (not shown) may be formed between the waveguide (i.e., a core layer of the waveguide) and substrate 706. Absorption layer 708 is deposited below substrate 706. Substrate 706 is between absorption layer 708 and the waveguides. Unlike configuration 500 shown in FIGS. 7A-7D, no grating layer is formed at the top of the waveguides 703-705. Holes 701 pass through substrate 706 and absorption layer 708 completely. Holes 702 penetrate substrate 706 and absorption layer 708 completely, and reach the core layer of the waveguide by penetrating it partially. Holes 702 may function as a defect of the waveguide. Light waves travelling in the waveguide interact with holes 702, generating leaky waves. Part of the leaky wave comes out of holes 702 and becomes an array of reference beams propagating against the Z direction.

Holes 701 and 702 have a dimension (or diameter) close to or smaller than the wavelength of the light waves. Each hole 701 is spaced apart from an adjacent hole 702 with a separation between them close to or smaller than the wavelength in the Y direction. A sensing unit 713 of configuration 700 contains a pair of adjacent holes 701 and 702. An imaging mechanism/device may be built based on configuration 700. When a beam from a sample is focused on an XY plane of substrate 706, part of the beam passes through holes 701 respectively and is transformed into signal beams propagating against the Z direction. The signal beams form an image of the sample.

Similar to configuration 500, a pair of adjacent signal and reference beams generated at a sensing unit 713 has dimensions and a separation close to or smaller than the wavelength in the XY plane. The signal and reference beams interfere to produce an output beam. The signal beam may be detected be sensing the output beam. The image may be obtained using detection results of the output beams at the sensing units. Similar to configuration 500, in order to prevent stray beams from entering holes 701, sidewalls of holes 701 and the waveguides 703-705 may be coated with a reflective layer.

FIG. 10 illustrates schematically an arrangement 800 for detecting an image formed by weak beams. Arrangement 800 may be used to build a LiDAR, LCI, or OCT system. The arrangement includes a light source 801, phase modulators 802-805, attenuators 806-809, an array structure 810, and splitting structures 815-817. Array structure 810 contains waveguides W1-W4 that are parallel to each other and form a 1D waveguide array. Splitting structures 815-817 may be Y-shaped waveguide structures that split a beam into two parts with a split ratio of 50:50.

Light source 810 launches a beam in a waveguide. Splitting structure 815 splits the beam into two parts and each part is split again by splitting structures 816 and 817, respectively. As such, four beams are fed into waveguides W1-W4, respectively. Optionally, another splitting structure (not shown) may be disposed between light source 801 and splitting structure 815, and split the beam into a first portion and a second portion. The first portion travels to splitting structure 815, while the second portion is transmitted to a target as a probe beam. As shown in FIG. 10, the beam in waveguide W1 passes through phase modulator 802 and attenuator 806, and then enters array structure 810.

The structure of array structure 810 may be similar to one of the above-illustrated configurations, such as configuration 500 or 700. The above-described detection methods may be used for arrangement 800. For example, array structure 810 may have an array of first holes and an array of second holes. The array of the first holes is configured to receive reflected light from the target for producing signal beams. The signal beams carry an image of the target. The array of the second holes is formed on the waveguides W1-W4 for generating an array of reference beams. A pair of adjacent first and second holes forms a sensing unit of array structure 810. Interference between adjacent signal and reference beams at a sensing unit generates an output beam that is ascertained to determine the status of a pixel of the image. The sensing units form a sensing array, such as a 4×4 array at array structure 810 which is exemplarily shown in FIG. 10. As a pixel corresponds to a sensing unit, array structure 810 provides a 4×4 pixel array.

When a light wave propagates in waveguide W1, it passes sensing units P1, P2, P3, and P4 sequentially, and creates four reference beams at different times. As such, when signal beams from the target interfere with reference beams from the waveguides, the values of phase difference are different among the sensing units. For example, when a pair of adjacent signal and reference beams is in phase, other pairs of adjacent signal and reference beams might not be in phase. When a detection condition requires that adjacent signal and reference beams have a certain phase difference, e.g., in phase or out of phase (i.e., 180 degrees out of phase), the phase of each reference beam may be tuned separately to meet the condition.

For example, phase modulator 802 may adjust the phase of one reference beam among the four at sensing units P1-P4 at a time. In addition, when the phase of a reference beam is tuned, attenuator 806 may adjust the power level of the reference beam at the same time. As such, when a signal beam is sensed, the phase and power of its adjacent reference beam may be adjusted specifically to reach a predetermined sensing condition. Such a tuning process may be repeated for each pair of signal and reference beams at the sensing units. An image may be obtained after all signal beams are measured, i.e., all pixels are measured.

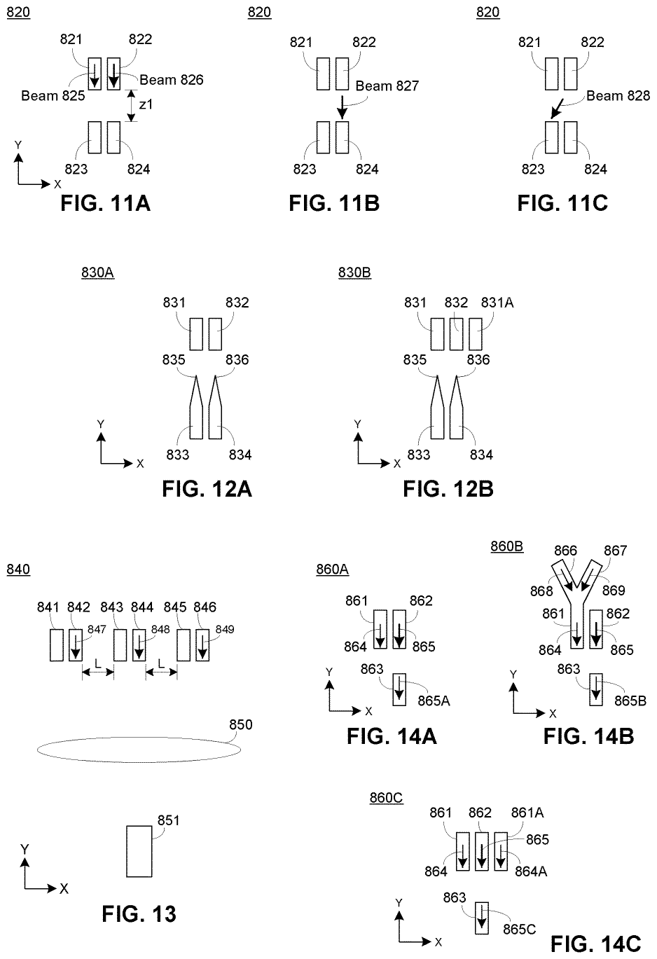

FIGS. 11A to 11C schematically illustrate top views of an optical switch 820 according to embodiments of the present disclosure. The term “optical switch”, as used herein, also indicates an optical switching system. The top views are in an X-Y plane. Similar to waveguides 16 and 17 shown in FIGS. 2A and 2B, waveguides 821, 822, 823, and 824 may be formed on a substrate (not shown) and have a width w1 in the X direction and height h1 in the Z direction. Waveguides 821-824 may each extend in the Y direction. The ends of waveguides 821 and 822 are aligned to a position at the Y axis. Waveguide 824 is beside waveguide 823 in the X direction. Waveguides 821-824 are disposed in the air or vacuum. The spacing between waveguides 821 and 822 is d1 in the X direction. Coherent beams 825 and 826 propagate in waveguides 821 and 822, respectively. The width w1, height h1, and spacing d1 are around or smaller than the wavelength of beams 825 and 826, respectively.

As shown in FIG. 11A, the distance between waveguides 821 and 822 and waveguides 823 and 824 is z1 in the Y direction. The distance z1 is also a distance between the emitting end of waveguides 822 and the receiving end of waveguide 824 in the Y direction. The value of z1 is determined based on configurations of the waveguides and coupling mechanisms of switch 820. Waveguide 824 is parallel to waveguides 821 and 822. In some embodiments, waveguide 824 is aligned to a position of waveguide 822 at the X axis. That is, the emitting end of waveguides 822 faces the receiving end of waveguide 824 in the Y direction. Optionally, waveguide 824 may be aligned to a position between waveguides 821 and 822 in the X direction, e.g., a midpoint in the X direction. Waveguides 823 and 824 are arranged side by side in the X direction. Optionally, waveguide 823 may be parallel to or has an angle with waveguide 824. The position and orientation angle of waveguide 823 in an X-Y plane may be arranged to minimize power loss.

When the spacing, width, and height of waveguides 821 and 822 are around or smaller than the wavelength, beams 825 and 826 are entirely transmitted into a tiny space with dimensions around or smaller than the wavelength in the X and Z directions. Beams 825 and 826 mix and interfere with each other to form an output beam. Due to the aforementioned beam singularity effect, the output beam is a single beam within the tiny space. Assuming beam 825 is used as a control beam to control the propagation direction and characteristics of the output beam. In some cases, beams 825 and 826 may have similar power values. Optionally, beam 825 may be a weak beam, while beam 826 a strong beam. The power of beam 826 may be 2 to 10 times or more than 10 times that of beam 825. The propagation direction and intensity distribution of the output beam is determined by the power difference and phase difference between beams 825 and 826. The output beam may be steered by control beam 825 and coupled into waveguide 823 or waveguide 824. As such, the output beam is switched optically.

Exemplarily, when beams 825 and 826 are in phase, i.e., with a phase difference around zero degree, the output beam may be coupled into waveguide 824 as shown in FIG. 11B. When the phase difference between beams 825 and 826 is a given value, e.g., in a range between 45 to 90 degrees, the output beam may be coupled into waveguide 823 as shown in FIG. 11C. Thus, either waveguide 823 or waveguide 824 receives the output beam in two switching modes. Optionally, a lens system or a coupling system (not shown) may be disposed between waveguides 821 and 822 and waveguides 823 and 824 to reduce power loss during switching.

In some embodiments, optical switch 820 may have three waveguides, e.g., waveguides 821 and 822 for emitting beams 825 and 826 and waveguide 824 for receiving the output beam. In such a scenario, there are three switching modes. When beam 825, as the control beam, is off or has power smaller than a given value and beam 826 has power above a given level, the output beam is transmitted to waveguide 824, and the switch is turned on. When both beams 825 and 826 are on, in phase, and with similar power levels or beam 825 is weaker by a factor of at least 2-5, constructive interference occurs and the output beam is coupled into waveguide 824. Then, the switch is also turned on. In the above two switch-on modes, the positions of waveguide 824 may be arranged differently to reduce power loss. When beams 825 and 826 are on, out of phase (i.e., 180 degrees out of phase), and with similar power levels or beam 825 being weaker by a factor of at least 2-10, destructive interference occurs and the output beam is not coupled into waveguide 824 to a certain extent, and the switch is turned off.

FIG. 12A schematically illustrates a top view of an optical switch 830A according to embodiments of the present disclosure. The top view is in an X-Y plane. Optical switch 830A has a similar structure and similar switching mechanisms to that of optical switch 820 shown in FIG. 11A. Optical switch 830A contains waveguides 831, 832, 833, and 834 that may be formed on a substrate (not shown). Like waveguides 821-824, the width and height of waveguides 831-834 and the spacing between waveguides 831 and 832 in the X direction are around or smaller than the wavelength of beams transmitted. Different from receiving waveguides 823 and 824, receiving waveguides 833 and 834 have tapered ends 835 and 836, respectively, as shown in FIG. 12A. The tapered portions have gradually reduced dimensions at least in an X-Y plane along a direction (e.g., the Y direction). Tapered ends 835 and 836 are arranged to reduce power loss during switching by improving the coupling efficiency between an output beam and waveguides 833 and 834. Further, profiles of the tapered portions in X-Z planes and the length of the tapered portions in the Y direction may be optimized to improve coupling efficiency.

The distance between waveguides 831 and 832 and tapered ends 835 and 836 in the Y direction may be determined based on configurations of the waveguides and coupling mechanisms of switch 830A. A beam emitted from waveguide 831 may be used as a control beam to control the switching status. Waveguide 834 is parallel to waveguides 831 and 832. In some embodiments, waveguide 834 is aligned to a position of waveguide 832 at the X axis. In some cases, waveguide 834 may be aligned to a position between waveguides 831 and 832, e.g., a midpoint along the X direction. Waveguides 833 and 834 are arranged side by side in the X direction. Optionally, waveguide 833 may be parallel to or has an angle with waveguide 834. The position and orientation angle of waveguide 833 in the X-Y plane may be adjusted to minimize power loss.

Optical switches 820 and 830A have the same or similar switching mechanisms. Like beams 825 and 826, beams in waveguides 831 and 832 may have similar power levels or be a pair of weak and strong beams. The power difference and phase difference between the beams in waveguides 831 and 832 may be used to control the on and off status of switch 830A in the same manner as that of switch 820. In some cases, a lens system or coupling system (not shown) may be disposed between waveguides 831 and 832 and waveguides 833 and 834 to reduce power loss.

Optionally, optical switch 830A may contain only three waveguides, e.g., waveguides 831, 832, and 834. In such a case, optical switch 830A may operate in the same manner as that of optical switch 320 when optical switch 320 has only three waveguides.

In some embodiments, an additional waveguide may be added to optical switch 830A. The additional waveguide emits another control beam, which may be used to reduce power loss and improve switching performance. As shown in FIG. 12B, a waveguide 831A is arranged beside waveguide 832, forming an optical switch 830B. The structural difference between switches 830A and 830B is the added waveguide 831A. Waveguide 832 is disposed between waveguides 831 and 831A in the X direction. Optionally, waveguides 831 and 831A may have the same structure and are positioned symmetric to the center of waveguide 832 in the X direction. The two control beams in waveguides 831 and 831A have similar power levels. The two control beams may have similar power to that of the beam propagating in waveguide 832 in some cases or weaker by a factor of at least 2-10. Similar to switch 830A, beams are emitted from waveguides 831, 831A, and 832 to form an output beam. The beams from waveguides 831, 831A, and 832 are entirely transmitted into a tiny space with dimensions around or smaller than the wavelength in the X and Z directions. The output beam is generated as a single beam in the tiny space. Propagation direction of the output beam may be steered by adjusting phases of the two control beams, respectively. Intensity distribution of the output beam may be tuned by adjusting the power of the two control beams.

In some embodiments, the output beam is switched between being coupled into waveguide 833 or 834. In some other embodiments, only waveguide 834 is arranged as the receiving waveguide. The two control beams are used to couple the output beam into waveguide 834 or make a hollow output beam with low coupling efficiency to waveguide 834. The term “hollow beam”, as used herein, indicates a central part of a beam has lower power intensity than a side part or the power intensity increases from the center of the beam in an outward direction, reaches a maximum value, and then decreases. A hollow output beam may be formed when the two control beams and the beam in waveguide 832 are out of phase.

FIG. 13 schematically illustrates a top view of an optical switch 840 according to embodiments of the present disclosure. The top view is in an X-Y plane. Optical switch 840 contains emitting units arranged in a 1D array in the X direction. Each emitting unit has a pair of waveguides, such as waveguides 841 and 842, 843 and 844, and 845 and 846. The pairs of waveguides have a similar structure and similar arrangement to that of waveguides 821 and 822 shown in FIG. 11A. Waveguides 841-846 are parallel to the Y axis and may be formed on a substrate (not shown). Like waveguides 821 and 822, the width, height, and spacing between waveguides of each pair are around or smaller than the wavelength of beams transmitted. Assuming a distance between adjacent emitting units, e.g., between waveguides 842 and 843, is L, as shown in FIG. 13. The value of L may be larger than twice the wavelength in some cases.

Optical switch 840 further includes a lens system 850 and a receiving waveguide 851. The 1D emitting unit array, lens system 850, and waveguide 851 are aligned along the Y direction and positioned to reduce power loss. Beams traveling in waveguides 841, 843, and 845 may be used as control beams to control switch 840 collectively. Coherent beams 847, 848, and 849 travel in waveguides 842, 844, and 846, respectively, as shown in FIG. 13. Assuming the control beams and beams 847-849 are out of phase. When the control beams are off or have power low enough, beams 847-849 form an output beam that is coupled into waveguide 851 through lens system 850. Consequently, switch 840 is turned on. When the power of the control beams is similar to, smaller than, or much smaller than (e.g. at least 2-10 times smaller) the power of beams 847-849, destructive inference occurs. The power coupled into waveguide 851 is reduced. Switch 840 is turned off.

In some embodiments, an additional waveguide (not shown) may be added to each emitting unit to introduce two control beams. The emitting unit may have a similar structure and a similar configuration to that formed by waveguides 831, 832, and 831A as shown in FIG. 12B. In a similar manner to that of switch 830B, the two control beams in an emitting unit are used to reduce power loss and improve switching performance. The control beams may be turned on or off to control switch 840.

FIG. 14A schematically illustrates a top view of an optical transistor 860A according to embodiments of the present disclosure. The top view is in an X-Y plane. Optical transistor 860A has a similar structure to that of optical switch 820. Different from optical switch 820 shown in FIG. 11A, optical transistor 860A has only one receiving waveguide. Optical transistor 860A contains waveguides 861, 862, and 863 that may be fabricated on a substrate (not shown). Waveguides 861-863 each have a width in the X direction and height in the Z direction and extend in the Y direction. Waveguides 861 and 862 are emitting waveguides and waveguide 863 is a receiving waveguide. Like waveguides 821 and 822, the width and height of waveguides 861-863 and spacing between waveguides 861 and 862 are around or smaller than the wavelength of beams transmitted. In some cases, waveguide 863 may have the same structure as waveguide 824 of optical switch 820. Optionally, waveguide 863 may have a tapered end similar to tapered end 836 shown in FIG. 12A. The tapered end may be used to reduce power loss. Waveguide 863 is parallel to waveguides 861 and 862. In some embodiments, waveguide 863 is aligned to waveguide 862 in the Y direction or with respect to a point at the X axis. Waveguides 861 and 862 are arranged side by side in the X direction. The distance between waveguides 862 and 863 (or between the emitting end of waveguides 862 and the receiving end of waveguide 863) in the Y direction is arranged based on characteristics and configurations of the waveguides 861-863 and coupling mechanisms for optimized coupling efficiency.

Beams 864, 865, and 865A propagate in waveguides 861, 862, and 863, respectively. Beam 864 may be referred to as an input beam. Beam 865 may be referred to as a source beam. After being emitted, beams 864 and 865 interfere. Beams 864 and 865 are entirely transmitted into a tiny space with dimensions around or smaller than the wavelength in the X and Z directions. An output beam is generated from interference between beams 864 and 865. Due to the aforementioned beam singularity effect, the output beam is a single beam within the tiny space in front of waveguides 861 and 862. Input beam 864 is used to control the output beam. The output beam is coupled into or received by waveguide 863 and becomes beam 865A. The status of beam 865A represents the output of transistor 860A. Input beam 864 and source beam 865 are arranged out of phase. The power of input beam 864 may be similar to, smaller than, or much smaller than (e.g., at least 2-10 times smaller) that of source beam 865. Optionally, a lens system or coupling system (not shown) may be disposed between waveguides 862 and 863 to reduce power loss.

When beam 864 is turned off or has low power (e.g., below a given value), beam 865 is coupled into waveguide 863 and beam 865A has high power (e.g., above a certain value). When beam 864 is turned on and has high power, destructive interference occurs between beams 864 and 865. The output beam is not coupled into waveguide 863 to a certain extent and beam 865A has low power. As such, at optical transistor 860A, when the input has low power, the output has high power; and when the input has high power, the output has low power. Transistor 860A may be used to form logic gates.

In some embodiments, waveguides 866 and 867 and a Y structure (or a coupling structure) may be added to optical transistor 860A to create an optical transistor 860B, as shown in FIG. 14B. Waveguide 866 and 867 are connected to input ports of the Y structure. Waveguide 861 is connected to the output port of the Y structure. Beams 868 and 869 propagate in waveguides 866 and 867 respectively and then merge through the Y structure to generate beam 864 in waveguide 861. Assuming the Y structure has a 50:50 split ratio. Assuming beams 868 and 869 are out of phase. Beam 868 serves as an input beam and is in phase with source beam 865 after exiting the Y structure, while beam 869 serves as a base beam and is out of phase with source beam 865 after exiting the Y structure. The power of beams 868 and 869 may be smaller or much smaller than that of source beam 865, e.g., by a factor of at least 2-10.

Assuming base beam 869 is always on with fixed power. When input beam 868 is turned off or has low power (e.g., weaker or much weaker than beam 869), part of base beam 869 is coupled into waveguide 861 and becomes beam 864. Destructive interference occurs between beams 864 and 865. The output beam is not coupled into waveguide 863 to a certain extent and beam 865B has low power. When input beam 868 is turned on and has high power (e.g., stronger than beam 869), it dominates in the destructive interference at the Y structure. Beam 864 becomes in phase with beam 865. Consequently, the output beam is coupled into waveguide 863 and beam 865B has relatively high power. As such, at optical transistor 860B, when the input has low power, the output has low power; and when the input has high power, the output has high power. Transistor 860B may be used to form logic gates, too. Optionally, when beam 865B is stronger than input beam 868, the transistor may be used as an optical amplifier.

Still referring to FIG. 14B, in some embodiments, beam 868 serves as an input beam and is out of phase with source beam 865 after exiting the Y structure, while beam 869 serves as a base beam and is in phase with source beam 865 after exiting the Y structure. The power of beams 868 and 869 may be smaller or much smaller than that of source beam 865. Assuming base beam 869 is always on with fixed power. When input beam 868 is weaker than base beam 869, beam 864 is in phase with source beam 865. Beam 865B has high power. When input beam 868 is stronger than base beam 869, beam 864 is out of phase with source beam 865. Beam 865B has low power. Thus, for optical transistor 860B with such conditions, when the input has low power, the output has high power; and when the input has high power, the output has low power.

In some embodiments, another waveguide transmitting a second input beam may be added to optical transistor 860A. As shown in FIG. 14C, a waveguide 861A is arranged beside waveguide 862, forming an optical transistor 860C. Waveguide 861A carries a second control beam 864A, which is used to improve the performance. The main structural difference between transistors 860A and 860C is the added waveguide 861A. Waveguide 861 and 861A have the same structure and are positioned symmetric to the center of waveguide 862 in the X direction. Input beams 864 and 864A have similar power levels and are approximately in phase. The power of source beam 865 may be similar to, stronger than, or much stronger than that of input beams 864 and 864A, e.g., by a factor of at least 2-10. Input beams 864 and 864A and source beam 865 are arranged out of phase.

When input beams 864 and 864A are turned off or have a power level low enough, the output beam (or source beam 865) is coupled into waveguide 863 to generate a beam 865C with relatively high power. When input beams 864 and 864A have certain power, beams 864, 864A, and 865 are entirely transmitted into a tiny space with dimensions around or smaller than the wavelength in the X and Z directions. Destructive interference occurs among the beams. A single hollow output beam is generated and consequently the output beam is not coupled into waveguide 863 to a certain extent. As such, beam 865C has low power. Thus, at optical transistor 860C, when the input has low power, the output has high power; and when the input has high power, the output has low power.

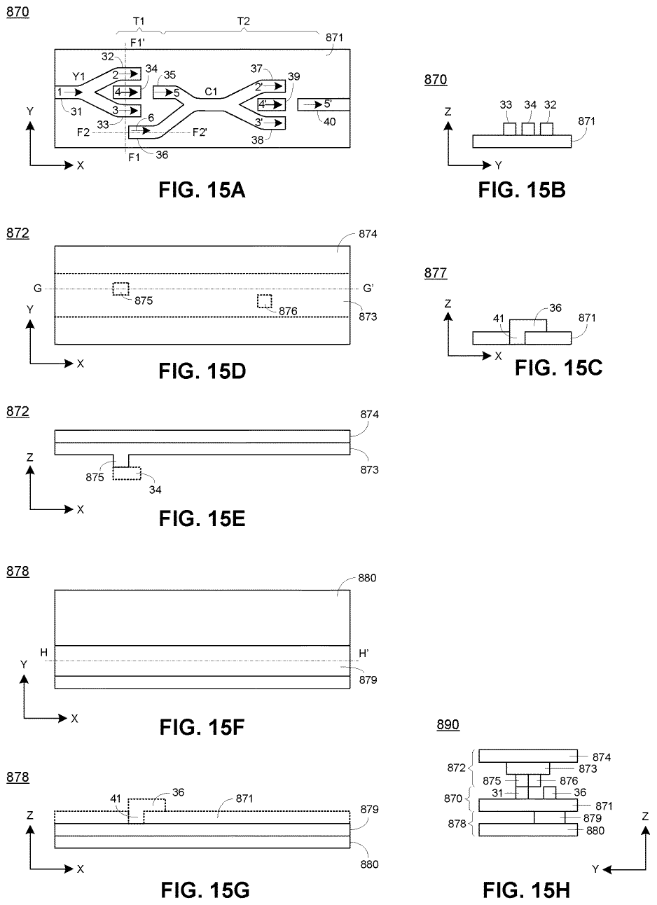

FIGS. 15A-15H show schematic views of an optical transistor configuration 890 according to embodiments of the present disclosure. Configuration 890 contains a transistor section 870 and two source sections 872 and 878. Transistor section 870 is disposed between the two source sections. FIGS. 15A and 15F illustrate top views of transistor section 870 and source section 878, respectively. FIGS. 15B and 15C respectively illustrate cross-sectional views of transistor section 870 taken along a line F1F1′ and a line F2F2′ depicted in FIG. 15A, where FIG. 15C shows a configuration 877 that is a part of transistor section 870. FIG. 15D illustrates a bottom view of source section 872. FIG. 15E illustrates a cross-sectional view of source section 872 taken along a line GG′ depicted in FIG. 15D when source section 872 is placed upside down. FIG. 15G illustrates a cross-sectional view of source section 878 taken along a line HH′ depicted in FIG. 15F. FIG. 15H illustrates a side view of configuration 890 where source section 872 is arranged upside down. Waveguides at optical transistor configuration 890 are made of the same material, while substrates are made of materials different from the waveguides. Arrows in the figures indicate propagation directions of beams in the waveguides.

Referring to FIG. 15A, waveguides 31-40 are fabricated on a substrate 871. Like waveguides 861 and 862, the width and height of waveguides 31-40 are around or smaller than the wavelength of beams transmitted. Spacings between adjacent ones among waveguides 32, 33, and 34 and among waveguides 37, 38, and 39 are equal and around or smaller than the wavelength in the Y direction.

A beam 1 propagates in waveguide 31. Beam 1 is split into beams 2 and 3 by a Y structure Y1. An optical transistor T1 contains waveguide 32-35. Beams 2 and 3 serve as input beams propagating in waveguides 32 and 33, respectively. A beam 4 is a source beam traveling in waveguide 34. Beams 2, 3, and 4 are coherent. Beams 2 and 3 are in phase and arranged out of phase with beam 4. The output beam of transistor T1 is coupled into waveguide 35. The coupled part of the output beam becomes a beam 5 in waveguide 35. Transistor T1 functions in the same way as transistor 860C shown in FIG. 14C. When the input (i.e., beam 1) of transistor T1 has low power (e.g., below a certain value), the output (i.e., beam 5) has high power; and when the input has high power, the output has low power.

Transistor section 870 further contains another optical transistor T2 that includes waveguide 35-40 and a 2×2 coupler C1 with a 50:50 split ratio. A beam 6 travels in waveguide 36 and serves as a base beam, while beam 5 serves as an input beam. Beams 5 and 6 are arranged out of phase. Waveguides 35 and 36 are connected to input ports of coupler C1. Waveguides 37 and 38 are connected to output ports of coupler C1. Coupler C1 has coupling and splitting functions. Assuming base beam 6 is always on with fixed power. When beam 5 has low power (e.g., below a certain value or weaker than beam 6), beam 6 dominates in destructive interference. Part of beam 6 exits coupler C1 and becomes beams 2′ and 3′, propagating in waveguides 37 and 38, respectively. A beam 4′ is a source beam traveling in waveguide 39. Beams 2′ and 3′ have approximately the same phase and same power. Further, beams 2′ and 3′ and beam 4′ are arranged out of phase for generating a hollow output beam. The hollow output beam is not coupled into waveguide 40 to a certain extent. A coupled part of the output beam becomes a low power beam 5′ in waveguide 40.

When beam 5 has high power (e.g., stronger than beam 6), beam 6 is canceled in destructive interference at coupler C1. Remaining part of beam 5 becomes beams 2′ and 3′. Beams 2′ and 3′ and source beam 4′ are arranged in phase. Constructive interference among the beams generates an output beam. The output beam is coupled into waveguide 40, generating beam 5′ with relatively high power. Thus, transistor T2 functions in the same way as transistor 860B shown in FIG. 14B. When the input (i.e., beam 5) has low power, the output (i.e., beam 5′) has low power; and when the input has high power, the output has high power.

Most parts of waveguides 31-40 are formed over substrate 871, as illustrated in FIG. 15B. As shown in FIG. 15C, however, waveguide 36 has a protruding portion 41 extending through substrate 871 against the Z direction. Protruding portion 41 has the same material as that of the waveguides and is used to couple beams from source section 878 into waveguide 36 to create beam 6.

Source section 872 includes a waveguide 873 disposed on a substrate 874. As shown in FIGS. 15D and 15E, when source section 872 is placed upside down, waveguide 873 is under substrate 874. Optionally, waveguide 873 extends in the X direction and is arranged to transmit single mode beams propagating in the X direction, providing beams such as source beams to optical transistors at transistor section 870. The single mode beams are always on in waveguide 873 during operation of the transistors. The width of waveguide 873 in the Y direction is around or smaller than the wavelength. The height of waveguide 873 in the Z direction is smaller than the wavelength. Waveguide 873 contains splitting parts 875 and 876 that extending and pointing against the Z direction when source section 872 is upside down, as shown in dotted lines in FIG. 15D and more explicitly in FIG. 15E. Splitting parts 875 and 876 and waveguide 873 include the same material. The position of waveguide 34 of transistor section 870 is depicted in dotted line in FIG. 15E. Splitting part 875 and segments of waveguides 34 and 873 form a first coupling structure that couples a fraction (e.g., smaller than 0.1-1%) of beams of waveguide 873 into waveguide 34 to generate source beam 4. Splitting part 876 and segments of waveguides 39 and 873 form a second coupling structure that coupled a fraction of beams of waveguide 873 into waveguide 39 to generate source beam 4′. Splitting parts 875 and 876 may be bonded with corresponding waveguides using adhesive materials that have matching refractive index to reduce power loss.

As shown in FIGS. 15F and 15G, source section 878 includes a waveguide 879 disposed on a substrate 880. Like waveguide 873, waveguide 879 extends in the X direction and is arranged to transmit single mode beams propagating in the X direction. Waveguide 879 provides beams to optical transistors at transistor section 870. The single mode beams are always on in the waveguide 879 during operation of the transistors. The width of waveguide 879 in the Y direction is around or smaller than the wavelength. The height of waveguide 879 in the Z direction is smaller than the wavelength. Protruding portion 41 of transistor section 870 is used to extract a beam from waveguide 879. Positions of waveguide 36, protruding portion 41, and substrate 871 are depicted in dotted lines in FIG. 15G. Protruding portion 41 is in contact with a region of waveguide 879, where adhesives may be used to avoid gaps. Protruding portion 41 and segments of waveguides 36 and 879 form a third coupling structure that couples a fraction (e.g., smaller than 0.1-1%) of beams in waveguide 879 into waveguide 36 to generate beam 6.

As shown in FIG. 15H, transistor section 870 is arranged between source sections 872 and 878 in the Z direction. Source section 872 is upside down and on the top, while source section 878 is at the bottom. In some embodiments, the three sections may be fabricated and then assembled together by bonding to form configuration 890. Alternatively, integral configuration 890 may be made by deposition and etch processes to form source section 878, transistor section 870, and source section 872 sequentially over one substrate. Connections between adjacent sections are arranged through coupling structures, such as the first, second, or third coupling structure illustrated above.

The first coupling structure includes splitting part 875 and segments of waveguides 34 and 873 adjacent to splitting part 875. As shown in FIG. 15E, a segment of waveguide 34 and the top of splitting part 875 are aligned in an X-Y plane, in contact, and optionally bonded by adhesive materials. A beam propagating in waveguide 873 along the X direction is split by the first coupling structure, generating beam 4 in waveguide 34. Similarly, at the second coupling structure, a segment of waveguide 39 and the top of splitting part 876 are aligned in the X-Y plane, in contact, and optionally bonded by adhesive materials.

The third coupling structure includes protruding portion 41 and segments of waveguides 36 and 879. As shown in FIG. 15G, the end of protruding portion 41 and a segment of waveguide 879 are aligned in an X-Y plane, in contact, and optionally bonded by adhesive materials.

Optionally, beams propagating in waveguides 873 and 879 along the X direction may be arranged out of phase with respect to a position at the X axis. It provides two options for generating a beam with certain phase at transistor section 870. After a beam is injected in a waveguide of transistor section 870, the phase of the beam may be tuned by arrangements (e.g. the length) of the waveguide.

In the above-illustrated embodiments of weak beam detection, optical switches, and optical transistors, shapes of cross-sections of the waveguides may be a rectangular, a square, a trapezoid, an oval, or a circle. For a circular waveguide such as nanowires, the diameter may be used as their width and height.

In some embodiments, optical transistor configuration 890 may be modified and changed into an optical transistor configuration 882 (not shown) by removing source section 878 or source section 872. Thus, configuration 882 only contains transistor section 870 and source section 872. A new coupling structure may be arranged at source section 872 to replace the third coupling structure. Like the first coupling structure, the new coupling structure may contain a splitting part (not shown) and segments of adjacent waveguides, coupling a fraction of beams of waveguide 873 into waveguide 36 to generate beam 6. The phase of beam 6 may be adjusted by the length and shape of waveguide 36 before beam 6 enters coupler C1. When source section 872 is removed, configuration 882 contains transistor section 870 and source section 878. Source section 878 may be modified by adding two new coupling structures to create beams 4 and 4′ from beams in waveguide 879, respectively.

In some embodiments, structures of the above illustrated optical switches may be used to make optical transistors. For example, switch structures shown in FIGS. 11A, 12A, and 12B may be utilized to construct transistors with mechanisms similar to that of transistors 860A, 860B, and 860C. In addition, waveguides 415, 417, and 421 as shown in FIG. 6 may also be used to construct a transistor. For example, signal beam 1 may be an input beam, reference beam 1 may be a source beam, and signal beam 2 may be a beam coupled into waveguide 421 from the output beam.

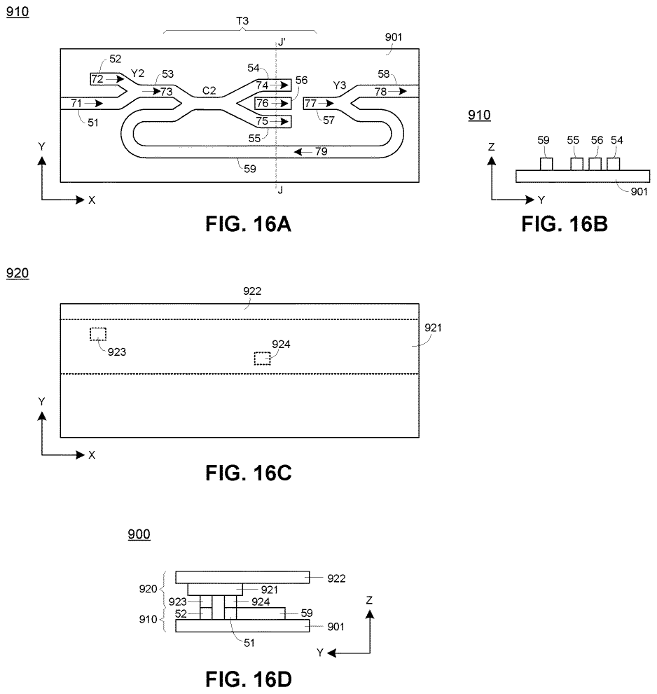

FIGS. 16A-16D show schematic diagrams of an optical memory unit 900 according to embodiments of the present disclosure. Optical memory unit 900 may also be referred to as an optical memory device. Optical memory unit 900 consists of a transistor section 910 and a source section 920. The source section 920 is disposed upside down and over transistor section 910. FIGS. 16A and 16C illustrate a top view of transistor section 910 and a bottom view of source section 920, respectively. FIG. 16B illustrates a cross-sectional view of transistor section 910 taken along a line JJ′ depicted in FIG. 16A. FIG. 16D illustrates a side view of optical memory unit 900. Arrows in the figures indicate propagation directions of beams in waveguides.

Referring to FIGS. 16A and 16B, waveguides 51-59 are arranged in an X-Y plane and fabricated on a substrate 901 in the same manner as waveguides 31-40 shown in FIG. 15A. Coherent beams 71-79 of a wavelength propagate in the waveguides, respectively. As the waveguides illustrated above, the width and height of waveguides 51-59 are around or smaller than the wavelength. Spacings between adjacent ones among waveguides 54, 55, and 56 are equal and around or smaller than the wavelength in the Y direction. Waveguides 51, 52, and 53 are connected to a Y structure Y2 that has a 50:50 split ratio. Waveguides 57, 58, and 59 are connected to a Y structure Y3. Y structure Y3 may have a 50:50 split ratio or another split ratio depending on actual needs. Waveguides 53 and 59 are also connected to input ports of a coupler C2, while waveguides 54 and 55 are connected to output ports of coupler C2. An input port of coupler C2 and an output port of Y structure Y3 are connected by waveguide 59. Coupler C2 has a 50:50 split ratio. An optical transistor T3 contains waveguides 53-57 and 59 and coupler C2. Transistor T3 functions in a similar manner to that of transistor 860B shown in FIG. 14B.

As shown in FIG. 16C, source section 920 is upside down and includes a waveguide 921 disposed on a substrate 922. Optionally, waveguide 921 extends in the X direction and is arranged to transmit single mode beams propagating in the X direction, providing beams such as source beams to optical transistors at transistor section 910. The single mode beams are always on in the waveguide 921 during operation of the transistors. The width of waveguide 921 in the Y direction is around or smaller than the wavelength. The height of waveguide 921 in the Z direction is smaller than the wavelength. Waveguide 921 contains splitting parts 923 and 924 that have a structure similar to or the same as splitting parts 875 and 876 shown in FIGS. 15D and 15E. For example, splitting parts 923 and 924 may protrude out of waveguide 921 in the vertical direction. Splitting part 923 and segments of waveguides 52 and 921 form a fourth coupling structure that coupled a fraction (e.g., smaller than 0.1-1%) of beams of waveguide 921 into waveguide 52 to generate beam 72. Splitting part 924 and segments of waveguides 56 and 921 form a fifth coupling structure that coupled a fraction of beams of waveguide 921 into waveguide 56 to generate source beam 76.

As shown in FIG. 16D, source section 920 is disposed on top of transistor section 910 with waveguide 921 under substrate 922. In some embodiments, the two sections may be fabricated separately and then assembled together by bonding using adhesive materials. Alternatively, an integral device may be made by deposition and etch processes to form transistor section 910 and source section 920 sequentially over one substrate. Connections between the two sections are arranged through coupling structures, such as the fourth and fifth coupling structures. In some embodiments, source section 920 may be disposed below transistor section 910 in a manner similar to source section 878 being disposed below transistor section 870 as shown in FIG. 15H. In such cases, the fourth and fifth coupling structures and waveguides 52 and 56 may be modified accordingly.

Back to FIG. 16A, beam 71 is a setting beam propagating in waveguide 51. Beam 72 is a preset beam traveling in waveguide 52 and transmitted from waveguide 921 via the fourth coupling structure illustrated above. Beam 72 is always on with a predetermined power level when transistor T3 is in operation. Beams 71 and 72 enter input ports of Y structure Y2, respectively. Beam 73 in waveguide 53 comes from the output port of Y structure Y2. Beam 73 serves as a base beam of transistor T3. An input beam of transistor T3 travels in waveguide 59. The base and input beams are combined by coupler C2, generating beams 74 and 75 in waveguides 54 and 55, respectively. Beams 74 and 75 are in phase and have similar power. As described above, waveguide 56 receives beam 76 from waveguide 921 through the fifth coupling structure. Inside transistor T3, waveguides 54-57 form another transistor structure similar to that of transistor 860C shown in FIG. 14C. Beam 76 works as a source beam. An output beam of transistor T3 is generated in a tiny space through interference among beams 74-76 and coupled into waveguide 57. Optionally, waveguide 57 may have a tapered end. In some cases, a lens system or coupling structure may be employed to improve the coupling efficiency. A coupled part of the output beam becomes beam 77 in waveguide 57. Beam 77 represents the output of transistor T3. Beam 77 is split into beams 78 and 79 traveling in waveguides 58 and 59 respectively by Y structure Y3. Beam 78 works as a status beam to show a memory state of optical memory unit 900. Beam 79 is transmitted to coupler C2 from Y structure Y3 through waveguide 59, becoming the input beam. Waveguide 59 has curved segments to turn the direction of beam 79 by 360 degrees.

In a storage period of optical memory unit 900, beam 71 is off. As illustrated above, beam 72 is always on with predetermined power. When beam 77 has relatively low power, beam 79 has low power. Beam 79 is arranged to be out of phase with beam 73 (e.g., through configurations of waveguides 53 and 59) when entering coupler C2. Compared to low power beam 79, the power of base beam 73 is arranged to be substantially greater. Beam 73 dominates in destructive interference between the beams that generates beams 74 and 75 at coupler C2. Beams 74 and 75 are arranged out of phase with beam 76. Further, the power of beams 74 and 75 is large enough for causing destructive interference with beam 76. Resultantly, the output beam becomes a hollow beam and is not coupled into waveguide 57 to a certain extent. Consequently, the power of beam 77 is relatively low. The low power of beam 77 is maintained.

When beam 77 has relatively high power, assuming the power of beam 79 is also relatively high. As aforementioned, beam 79 is arranged to be out of phase with beam 73 when reaching coupler C2. Compared to base beam 73, the power of input beam 79 is arranged to be greater. Beam 79 dominates in the destructive interference. Beams 74 and 75 depend on beam 79 and are in phase with beam 76. An output beam is formed by constructive interference. The output beam is coupled into waveguide 57 to a certain extent, generating beam 77 with relatively high power. The high power of beam 77 is maintained.

As such, when transistor T3 generates low power beam 77, part of beam 77 is feedbacked to transistor T3 as an input beam that causes transistor T3 to re-generate low-power beam 77. Low-power beam 77 is maintained continuously. Status beam 78 also has low power, showing one memory state of optical memory unit 900 continuously. On the other hand, when transistor T3 generates high-power beam 77, part of beam 77 is feedbacked to transistor T3 that causes transistor T3 to re-generate high power beam 77. High-power beam 77 is maintained continuously. Status beam 78 also has high power relatively, showing the other memory state of optical memory unit 900 continuously. Therefore, optical memory unit 900 may be used as static optical memory.

At a memory setting step, optical memory unit 900 may be set or reset by beam 71. If beam 71 is in phase with beam 72 when entering Y structure Y2, constructive interference at Y structure Y2 increases the power of base beam 73. The phase of base beam 73 remains unchanged before and after beam 71 is introduced in waveguide 51. Base beam 73 maintains out of phase with input beam 79. Beam 73 may be arranged to be stronger than beam 79 when beam 79 has high power. Further, the power of beam 73 is great enough to create destructive interference among beams 74-76 and generate low power beam 77 when beam 79 has either high or low power. Then optical memory unit 900 is set at low power and will maintain the low-power state. If beam 71 is out of phase with beam 72 when entering Y structure Y2, beam 73 is generated by destructive interference. Beam 71 is arranged to be stronger than beam 72. Then, the phase of beam 71 determines the phase of beam 73. Beams 73 and 79 become in phase. Further, the resultant beams 74 and 75 are in phase with beam 76 and have adequate power when beam 79 has either high power or low power. Constructive interference among beams 74-76 generates an output beam that is coupled into waveguide 57 to a certain extent to create high power beam 77. Then optical memory unit 900 is set at high power and will maintain the high-power state. After optical memory unit 900 is set or reset, beam 71 is turned off. Optionally, beam 71 may be a pulsed beam with a pulse duration long enough for setting or resetting optical memory unit 900.

In some embodiments, a source section, such as source section 872, 878, or 920, may have two or more waveguides that support single mode beams. For example, waveguide 873 as shown in FIG. 15D may be replaced by multiple waveguides (not shown) that are parallel and extend in the X direction. Beams in the waveguides may be in phase or have certain phase difference.

Although the description above contains many specificities, these should not be construed as limiting the scope of the invention but as merely providing illustrations of some of the presently preferred embodiments. Numerous modifications will be obvious to those skilled in the art. Therefore the scope of the invention should be determined by the appended claims and their legal equivalents, rather than by the examples given.

We claim:

1. An optical switch, comprising:
a first waveguide with a first width in a first direction and a first height in a second direction, extending in a third direction, and arranged for transmitting a first beam of a wavelength;
a second waveguide with a second width in the first direction and a second height in the second direction, extending in the third direction, and arranged for transmitting a second beam of the wavelength; and
a third waveguide with a third width in the first direction and a third height in the second direction and extending in the third direction, wherein the first, second, and third directions are perpendicular to each other, a first end of the first waveguide and a second end of the second waveguide are aligned, a first spacing is arranged between the first and second waveguides in the first direction, a second spacing is arranged between the second end of the second waveguide and a third end of the third waveguide in the third direction, the first and second beams are emitted through the first end and the second end respectively and arranged for forming an output beam, the third waveguide is arranged for receiving the output beam through the third end, and the first width, the second width, and the first spacing are smaller than one and a half times of the wavelength, respectively.

2. The optical switch according to claim 1 wherein the first height and the second height are smaller than one and a half times of the wavelength, respectively.

3. The optical switch according to claim 1, further comprising:
a fourth waveguide with a fourth width in the first direction and a fourth height in the second direction, extending in the third direction, arranged beside the second waveguide in the first direction, and arranged for transmitting a fourth beam of the wavelength, the first, second, and fourth beams arranged for forming the output beam.

4. The optical switch according to claim 1 wherein power of the second beam is at least twice power of the first beam.

5. The optical switch according to claim 1 wherein power and a phase of the first beam is used to control power of a beam received by the third waveguide and coupled from the output beam.

6. The optical switch according to claim 1, further comprising:
a fifth waveguide for receiving the output beam and arranged beside the third waveguide in the first direction.

7. The optical switch according to claim 6 wherein power and/or phase of the first beam is used to control power of a beam received by the third waveguide and power of a beam received by the fifth waveguide.

8. A method for optical switching, comprising:
providing a first waveguide with a first width in a first direction and a first height in a second direction, extending in a third direction, and arranged for transmitting a first beam of a wavelength;
providing a second waveguide with a second width in the first direction and a second height in the second direction, extending in the third direction, and arranged for transmitting a second beam of the wavelength;
providing a third waveguide with a third width in the first direction and a third height in the second direction and extending in the third direction, wherein the first, second, and third directions are perpendicular to each other, a first end of the first waveguide and a second end of the second waveguide are aligned, a first spacing is arranged between the first and second waveguides in the first direction, a second spacing is arranged between the second end of the second waveguide and a third end of the third waveguide in the third direction, the first and second beams are emitted through the first end and the second end respectively and arranged for forming an output beam, the third waveguide is arranged for receiving the output beam through the third end, and the first width, the second width, and the first spacing are smaller than one and a half times of the wavelength, respectively; and
using the first beam to control power of a beam obtained from the output beam by the third waveguide to perform switching.

9. The method according to claim 8 wherein the first height and the second height are smaller than one and a half times of the wavelength.

10. The method according to claim 8, further comprising:
providing a fourth waveguide with a fourth width in the first direction and a fourth height in the second direction, extending in the third direction, arranged beside the second waveguide in the first direction, and arranged for transmitting a fourth beam of the wavelength, the first, second, and fourth beams arranged for forming the output beam.

11. The method according to claim 8 wherein power of the second beam is at least twice power of the first beam.

12. The method according to claim 8 wherein power of the first beam is used to control power of a beam received by the third waveguide and coupled from the output beam.

13. The method according to claim 8, further comprising:
providing a fourth waveguide for receiving the output beam and arranged beside the third waveguide in the first direction.

14. The method according to claim 13, further comprising:
using power and/or phase of the first beam to control power of a beam received by the third waveguide and power of a beam received by the fourth waveguide.

15. A method for optical switching, comprising:
providing a first waveguide with a first width in a first direction and a first height in a second direction, extending in a third direction, and arranged for transmitting a first beam of a wavelength;
providing a second waveguide with a second width in the first direction and a second height in the second direction, extending in the third direction, and arranged for transmitting a second beam of the wavelength;
providing a third waveguide with a third width in the first direction and a third height in the second direction and extending in the third direction, wherein the first, second, and third directions are perpendicular to each other, a first end of the first waveguide and a second end of the second waveguide are aligned, a first spacing is arranged between the first and second waveguides in the first direction, a second spacing is arranged between the second end of the second waveguide and a third end of the third waveguide in the third direction, the first and second beams are emitted through the first end and the second end respectively and arranged for generating an output beam, the third waveguide is arranged for receiving the output beam through the third end, and the first and second beams are transmitted into a space with dimensions smaller than one and a half times of the wavelength in the first and second directions; and
using the first beam to control power of a beam received by the third waveguide from the output beam to perform the optical switching.

16. The method according to claim 15 wherein the first width, the second width, and the first spacing are smaller than one and a half times of the wavelength, respectively.

17. The method according to claim 15, further comprising:
providing a fourth waveguide with a fourth width in the first direction and a fourth height in the second direction, extending in the third direction, arranged beside the second waveguide in the first direction, and arranged for transmitting a fourth beam of the wavelength, the first, second, and fourth beams arranged for forming the output beam.

18. The method according to claim 15 wherein power of the second beam is at least twice power of the first beam.

19. The method according to claim 15 wherein power of the first beam is used to control power of a beam received by the third waveguide and coupled from the output beam.

20. The method according to claim 15, further comprising:
providing a fifth waveguide for receiving the output beam and arranged beside the third waveguide in the first direction.
